(19) United States
(12) Patent Application Publication
(10) Pub. No.: US 2010/0247723 A1
(43) Pub. Date: Sep. 30, 2010

(54) FROZEN DESSERT COMPOSITIONS HAVING INCREASED OVERRUN PERCENTAGE

(76) Inventor: Marvin J. Rudolph, Sharon, MA (US)

Correspondence Address: CESARI AND MCKENNA, LLP, 88 BLACK FALCON AVENUE, BOSTON, MA, 02210, US

(21) Appl. No.: 12/732,351

(22) Filed: Mar. 26, 2010

Related U.S. Application Data
(60) Provisional application No. 61/163,779, filed on Mar. 26, 2009.

(51) Int. Cl. A23G 9/46; A23G 9/00; A23G 9/04

(52) U.S. Cl. 426/329; 426/564; 426/568; 426/565

(57) ABSTRACT

The present invention utilizes a base mix formulated with an acidic agent so that when processed, into a frozen dessert product, the base mix provides an increased overrun percentage without increased costs of production. The base mix component may include any suitable food component, such as one or more dairy components (e.g., a milk or cream), a sugar and/or corn syrup component, an egg component, water, a stabilizer, a thickener, and/or the like. In illustrative embodiment of the present invention, the base mix may alternatively include a non-dairy component, such as soy milk and/or soy protein. Additionally, the base mix may also include an acidic agent to lower the pH to a level that results in an increase in the overrun percentage of the resulting frozen dessert product, while maintaining a desirable consistency and flavor of the frozen dessert product.

### CROSS-REFERENCE TO RELATED APPLICATIONS

The present application claims the benefit of U.S. Provisional Patent Application Ser. No. 61/163,779, which was filed on Mar. 26, 2009, by Marvin Jerry Rudolph for a FROZEN DESSERT COMPOSITIONS HAVING INCREASED OVERRUN and is hereby incorporated by reference.

### BACKGROUND OF THE INVENTION

1. Field of the Invention

The invention relates generally a system and method for increasing the overrun percentage of a frozen food product.

2. Background Information

Aerated frozen desserts, such as frozen ice cream or yogurt, are typically produced by mixing a dessert base mix with a specific volume of air in a continuous chiller to produce an aerated, semi-frozen slurry frozen dessert composition. The extent of aeration is typically defined in terms of “overrun.” The term “overrun” as applied to a food product indicates the change in density undergone by a given mass of the food product because of aeration. Thus, the percent overrun may be calculated by the formula: ((mass of mix−mass of same volume of ice cream)/(mass of same volume of ice cream)×100). The percentage of overrun ranges from 0 (no air) to infinity. Theoretically, a product comprising all air ((1−0)/0)=infinity. The accepted overrun limit for ice cream is 100%, which would amount to a frozen dessert composition that is half air. If overrun were to be 100%, in this instance, the final dessert composition would be twice the volume of the starting base mix. As such, dessert products that have larger overrun percentages are less costly (ice cream is sold by volume, not weight) and more efficient to produce because they require less base mix and result in optimum volumes of the final dessert product.

In addition, air volume, i.e., aeration, may influence certain physical properties of the final frozen dessert product. For example, if a frozen aerated dessert product, such as ice cream, were produced in a manner that did not include an aerating step, the resulting product would be a dense, solid composition. In contrast, if a frozen dessert product, such as ice cream, were to have a 100% overrun or greater, the final product would have a fluffy and dry appearance, would be mostly air, would have less flavor, and would melt extremely fast. In general, frozen dessert products typically have an overrun ranging from 20% to 100% overrun, with “premium” frozen desserts having an overrun less than 50%.

The amount of overrun percentage may be influenced by the ingredients provided in the base mix. For example, ingredients which are known to enhance overrun include sodium caseinate, whey solids, egg yolks, emulsifiers, such as lecithin and certain salts. However, such added ingredients are usually selected and proportioned in a manner so as to ensure that the overall unflavored base mix has a pH ranging from 6.3-6.8. When the pH of the base mix decreases from this range, thereby becoming more acidic, the resulting frozen dessert product typically becomes more sour or tart and at pH levels below the isoelectric point of casein, i.e., a pH of 4.6, will actually thicken and become too solid to process.

Accordingly, it would be advantageous to provide a base mix for a frozen dessert product that has an increased overrun percentage and is capable of maintaining a desirable consistency and flavor in the resulting product. Thus, there continues to be a needs for a base mix that provides optimum and efficient volumes of dessert product but does not burden the manufacturer with increased costs of production. The present disclosure meets these and other such needs.

### SUMMARY OF THE INVENTION

The present invention utilizes a base mix formulated with an acidic agent so that when processed, into a frozen dessert product, the base mix provides an increased overrun percentage without increased costs of production. The base mix component may include any suitable food component, such as one or more dairy components (e.g., a milk or cream), a sugar and/or corn syrup component, an egg component, water, a stabilizer, a thickener, and/or the like. In illustrative embodiment of the present invention, the base mix may alternatively include a non-dairy component, such as soy milk and/or soy protein. Additionally, the base mix may also include an acidic agent to lower the pH to a level that results in an increase in the overrun percentage of the resulting frozen dessert product, while maintaining a desirable consistency and flavor of the frozen dessert product.

As stated above, the subject base mix may include an acidic agent. Illustratively, the acidic agent may be a food grade acid, such as a citric or a phosphoric acid. The subject base mix may alternatively include a food grade acid precursor such as glucono-delta-lactone.

The base mix in the illustrative embodiment of the present invention is formulated and processed in a manner sufficient to increase the volume of a resultant dessert product. The resultant dessert product has an increase in overrun percentage when compared to a frozen dessert product produced from a base mix that is not so formulated and/or processed, e.g., does not include an additional acidic agent. The resulting dessert product of the present disclosure may have an overrun percentage in an amount ranging from about 25% to about 50%.

### BRIEF DESCRIPTION OF THE DRAWINGS

The invention description below refers to the accompanying drawings, of which:

FIG. 1 illustrates a diagrammatic view of the manufacturing and distribution system of the subject food compositions;

FIG. 2 is an exemplary pH meter and probe for measuring the adjusted pH of the subject base mix; and

FIG. 3 illustrates an isometric view, with parts broken away, showing an exemplary apparatus for producing and dispensing an aerated frozen product according to this invention.

### DETAILED DESCRIPTION OF AN ILLUSTRATIVE EMBODIMENT

Throughout this application, various publications, patents, and published patent applications are cited. The disclosures of these publications, patents, and published patent applications referenced in this application are hereby incorporated by reference in their entirety into the present disclosure. Citation herein by the Applicant of a publication, patent, or published patent application is not an admission by the Applicant of said publication, patent, or published patent application as prior art.

Aspects of the disclosure include a base mix for a dessert composition, such as a frozen dessert composition. The base mix may be such that when employed in the production of the dessert composition, the resultant dessert composition undergoes an increase in overrun percentage. The base mix component may include any suitable food component, such as one or more of a dairy component, e.g., a milk or cream component, a sugar and/or corn syrup component, an egg component, water, a stabilizer, thickener, and/or the like. Additionally, the base mix may include an acidic agent, such as an acidic agent that lowers the pH of the base mix to a point that produces an increase in the overrun percentage of a resulting frozen dessert produced by the processing of the base mix. Accordingly, a feature of the subject base mix is that it may include an acidic agent that lowers the pH of a resultant dessert product, e.g., a dessert product produced by the processing of the dessert mix, while maintaining a desirable consistency and flavor of the resultant dessert product.

### Base Mix

As summarized above, the subject base mix may include a number of ingredients for producing a frozen dessert. Any suitable ingredient may be included as long as the component is edible and safe to consume. In certain instances, the base mix may also include one or more individual components that may be mixed together to provide a composition that includes a nutritional value. Accordingly, the base mix component may include a dairy component (e.g., a milk or cream), a sugar and/or corn syrup component, an egg component, a stabilizer, a thickener, water, and/or the like.

Illustratively, the base mix component may include a dairy component, such as whole milk, skim milk, condensed milk, evaporated milk, anhydrous milk fat, cream, butter, butterfat, whey, and/or milk solids non-fat (MSNF). The dairy component may contribute dairy fat and/or non-fat milk solids such as lactose and milk proteins (e.g., whey proteins and caseins) to the overall edible composition. The diary component also includes a vegetable fat (e.g., cocoa butter, palm, palm kernel, soybean, cottonseed, coconut, rapeseed, canola, sunflower oils, and mixtures thereof). MSNF is typically made up of approximately 38% milk protein, 54% lactose, and 8% minerals and vitamins.

The base mix may further include a sugar source such as sucrose, glucose, fructose, lactose, dextrose, invert sugar in crystalline or liquid syrup form, or mixtures thereof. Alternatively the sugar source may also be a corn sweetener (dextrose and fructose), a dried corn syrup (corn syrup solids), a liquid corn syrup, a maltodextrin, glucose, or a mixture thereof. Sugar substitutes, sometimes called high performance sweeteners, such as sucralose, saccharin, sodium cyclamate, aspartame, and acesulfame may be used in addition to or in place of some or all of the above mentioned sugar sources.

Other ingredients may also be included in the base mix. The subject base mix may additionally include an egg component (e.g., egg whites and/or egg yolks), fruits (e.g., strawberries, blueberries, raspberries, blackberries, bananas, oranges, tangerines, melons, and the like), flavorings, and colorings. Thickeners and/or emulsifiers may also be added to the base mix. Emulsifiers may include, for example, lecithin, propylene glycol monostearate; sorbitan tristearate; lactylated monoglycerides and diglycerides; acetylated monoglycerides and diglycerides; unsaturated mono glycerides and diglycerides, including monoglycerides and diglycerides of oleic acid, linoleic acid, linolenic acid, or other commonly available higher unsaturated fatty acids; sucrose esters of various hydrophilic-lipophilic balance (HLB) and mixtures thereof. Emulsifiers typically comprise about 0.01% to about 3% of the base mix.

A stabilizer may also be added to the subject base mix component to help maintain acceptable organoleptic properties. These stabilizers may also be added to maintain homogeneity and to control ice-crystal growth during a freezing and/or aeration during a manufacturing process of a frozen dessert. In addition, various stabilizers may be included because of their ability to resist structural changes during heat shock, and/or temperature-cycling that may occur during transport, storage, and production of the food product. Furthermore, stabilizers or other components may be included to prevent ice-crystal formation occurring. Ice-crystal formation may lead to the deterioration of the overall composition due to structural changes. Thus, stabilizers provide for the uniform meltdown, mouth feel, and texture of a typical frozen dessert. In certain instances, a stabilizer may contain microcrystalline cellulose that has been co-processed with other hydrocolloid gums, such as, for example, alginate, guar gum, sodium carboxymethylcellulose or xanthan gum, any of which may be useful in the practice of the invention.

Where the base mix includes a plurality of components, the components can be pre-processed or non-processed. For instance, various components of the base mix may be pre-processed to be dehydrated and/or otherwise processed and added in the final mix composition in a dried and/or powder form. In other embodiments, various of the components of the base mix may be substantially non-processed, and may therefore be present in the final mix composition in its natural solid or fluid form. Accordingly, the base mix composition may be in any suitable form, such as a solid, liquid, dispersion, etc.

The base mix may also include a acidic agent, hereinafter the combination of the base mix and the acidic agent referred to a the “base mix composition.” For example, in one particular embodiment, the base mix composition may include the following:

| | |
|---|---|
| milk | 30% |
| cream | 15% |
| sugar | 5% |
| corn syrup | .5% |
| citric acid | .01% etc . . . |

In another particular embodiment, the base mix composition may include the following:

| | |
|---|---|
| milk | 28% |
| cream | 19% |
| sugar | 7% |
| corn syrup | .5% |
| phosphoric acid | .01% etc . . . |

In another particular embodiment, the base mix composition may include the following:

| | |
|---|---|
| milk | 28% |
| cream | 19% |
| sugar | 7% |
| corn syrup | .5% |
| glucono-delta-lactone acid | .01% etc . . . |

For the subject base mix compositions, the percent of an ingredient given is the percent by weight of the indicated ingredient based on the total weight of the mix. Except where indicated by context, terms such as stabilizer, emulsifier, flavoring, and similar terms also refer to mixtures of such materials.

As noted above, the base mix composition may also include additional components to enhance the overrun percentage. In certain aspects, the base mix may be include sodium caseinate, whey solids, egg yolks, emulsifiers and/or certain salts, egg albumin, phosphates, and citrates.

In another alternative embodiment of the present invention, the base mix may include an ingredient which will decrease overrun percentage. For example, the base mix may include NaCl or safflower oil to reduce the overrun percentage associated with the base mix.

### Acidic Agent

As discussed above, the base mix composition may illustratively includes an acidic agent to lower the pH of the base mix. The pH of the base mix composition is typically lowered to a point that results in an increase in overrun percentage of a resulting dessert product produced by the processing of the base mix composition. Advantageously, the acidic agent is able to lower the pH of the base mix composition while at the same time not affecting the consistency and/or flavor of the resulting frozen dessert product.

In the illustrative embodiment of the present invention the acidic agent may any one of a number of food acids used in the production and manufacturing of foods. Examples of food acids include, but are not limited to, acetic acid, adipic acid, citric acid, erythorbic acid, fumaric acid, lactic acid, malic acid, phosphoric acid, tartaric acid, and benzoic acid. Alternatively, carbonic acid, i.e., another viable food acid, may be formed by dissolving carbon dioxide gas in water under pressure, or by reacting an acid and the salt of a carbonate. In other embodiments of the present invention, however, the acidic agent may be an acid precursor such as glucono-delta-lactone.

As stated above, an acidic agent may be added to the base mix to lower the pH of the base mix composition. The pH may be lowered to a point that results in an increase in the overrun percentage of a resulting frozen dessert product produced by the processing of the dessert mix. Illustratively, the pH may be lowered from about 6.8 to about 4.7. The pH of the base mix composition may range from 4.8 to 5.5 while in other aspects of the present invention, the pH may range from 5.6 to 6.9. Embodiments of the invention include a base mix composition having a pH of 4.8, 4.9, 5.0, 5.1, 5.2, 5.3, 5.4, 5.5, 5.6, 5.7, 5.8, 5.9, 6.0, 6.1, 6.2, 6.3, 6.4, 6.5, 6.6, 6.7, 6.8, 6.9 or 7.0. In a specific embodiment, the pH of the base mix composition is 5.92.

### pH Adjustment

As discussed above, an acidic agent may be added to the base mix to lower the pH of the base mix composition to a point that results in an increased overrun percentage of the resulting dessert product. In certain instances, the acidic agent is added to the base mix and the pH is adjusted until the base mix composition has a desired pH, such as a pH ranging from 5.70 to 5.92. Advantageously, the lowering of the pH of the base mix composition results in an increase in overrun percentage, while at the same time not substantially affecting the consistency and flavor of a dessert product resulting from the processing of the dessert mix.

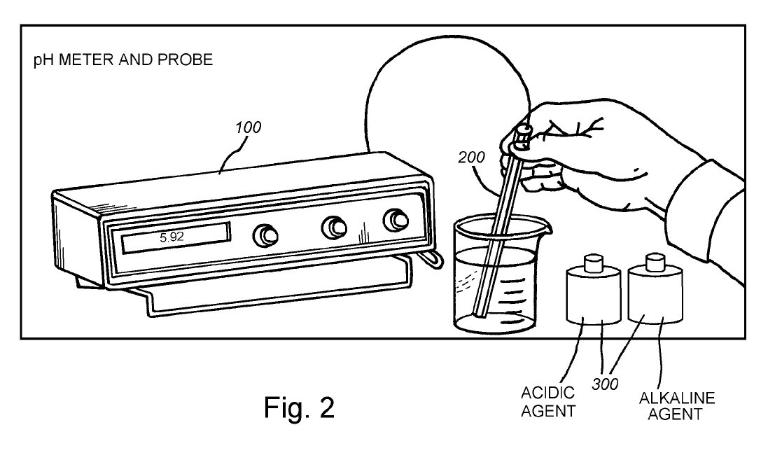

Any method known to one of ordinary skill in the art may be employed in determining the pH of the base mix composition in accordance with the present invention. For example, a pH probe and/or meter may be used in measuring and adjusting the pH of the base mix, to which an acidic agent may be added. A calibrated probe and/or meter may be used to measure the pH of the base mix composition as is depicted in FIG. 2. In FIG. 2, a sample of the subject base mix may be collected in a suitable container 200 such that there is enough sample to submerge the tip of the probe 300 into said container. The pH of the base mix sample may be read on the pH meter 100. If the pH is not the pH desired to increase overrun percentage, additional amounts of acidic agent 50 may be added to decrease the pH of the base mix composition or additional amounts of an alkaline 60 agent may be added to increase the pH.

For example, if a mix is too acidic, a food grade base, such as sodium hydroxide, potassium hydroxide, sodium carbonate or potassium carbonate, may be added to the base mix composition. Typically, however, potassium alkalizing agents are preferred over sodium in order to limit the amount of sodium in the diet.

Other examples of measuring pH include but are not limited to, litmus paper tests or the addition of a pH indicator into a sample of the base mix.

The above components, e.g., ingredients, may be mixed together to make up the base mix for producing a frozen dessert. For example, the ingredients may be mixed together as follows:

The fluid mix components (milk and cream) are added to a 50-gallon capacity “BreddoLikwifier” high shear mixer. The dry components (sugar, non fat dry milk, 10DE corn syrup solids, 36DE corn syrup solids, and a stabilizer (locust bean gum, guar gum, soy lecithin, carrageenan)) are added to the liquid utilizing a medium mixing speed in the mixer, to ensure thorough mixing but to avoid air incorporation and foaming due to excessive mixing. The acid is added last. The total mixing time for 10 gallons of total mix is about 20 minutes. A pH of a sample of the mix is taken by the pH meter after 20 minutes of mixing, and adjusted with acid or base to the target pH as necessary. Once the mix is the correct pH, the mix is processed through steam infusion.

Once all of the ingredients have been mixed together and the pH of the mix has been adjusted, the subject base mix may then be packaged and sterilized. In a production facility, the mix is aseptically packaged using an aseptic filler into a 2½-gallon bag (e.g. a Scholle bag) which has been sterilized by the addition of hydrogen peroxide. Illustratively, the sterilized mix is collected in a 10 gallon milk pail and poured into three-2½-gallon bags (Scholle bags) for refrigerated storage.

The mix reaches the temperature sterilization criteria at a temperature of 285° F. Once sterilized, the base mix composition is essentially free from foreign contaminants. Foreign contaminants are particles or microorganisms that deplete the nutrients within the subject base mix composition and/or is capable of causing the consumer of the resulting dessert product to become ill. Foreign contaminants may also cause the consumer to be ill. By the term “essentially” is meant that the pouch is at least 90% free of foreign contaminants. In certain embodiments, the pouch is at least 95% free of foreign contaminants and in other embodiments, the pouch is at least 100% free of foreign contaminants. Exemplary foreign contaminants include, but are not limited to, bacteria, molds and yeasts.

### Methods of Manufacturing the Base Mix Composition Having an Increased Overrun Percentage

As summarized above, the subject base mix composition may include an acidic agent or an acidic agent precursor. In the illustrative embodiment of the present invention, the base mix composition is manufactured at a factory in which the ingredients and the acidic agent are combined together and the pH of the combined mix is specifically determined. The base mix composition, including the acidic component, may be manufactured, packaged, and distributed at a manufacturing plant in aseptic liquid form so that the combined mix can be shipped to points of sale at room temperature without the costs related to refrigeration.

By “aseptic liquid form” is meant that the base mix composition is processed in a manner that includes an aseptic step, e.g., the application of heat or steam, which in turn sterilizes the base mix composition so that it will be stable at room temperature. This step protects the base mix composition from spoiling during storage and transportation since it will not otherwise be protected by temperature control, e.g., refrigeration. The base mix composition, including acidic component, may also be dehydrated or powdered, which would further reduce shipping and storage costs because the water content would be replaced at the production site of the finished product, e.g., the point of sale. The base mix composition, including an acid component, may be packaged for shipment in bulk. In the context of the present inventions, “bulk” means a quantity (by volume, by weight, or by other such measure) that is significantly greater than that of a typical consumer-sized serving. In the case of a food product, such as ice cream, a typical consumer-sized serving is commonly measured in single-digit “ounces”. For such a product, “bulk”, in contrast, might be measured in pounds or tens of pounds (or in terms of volume, gallons or tens of gallons).

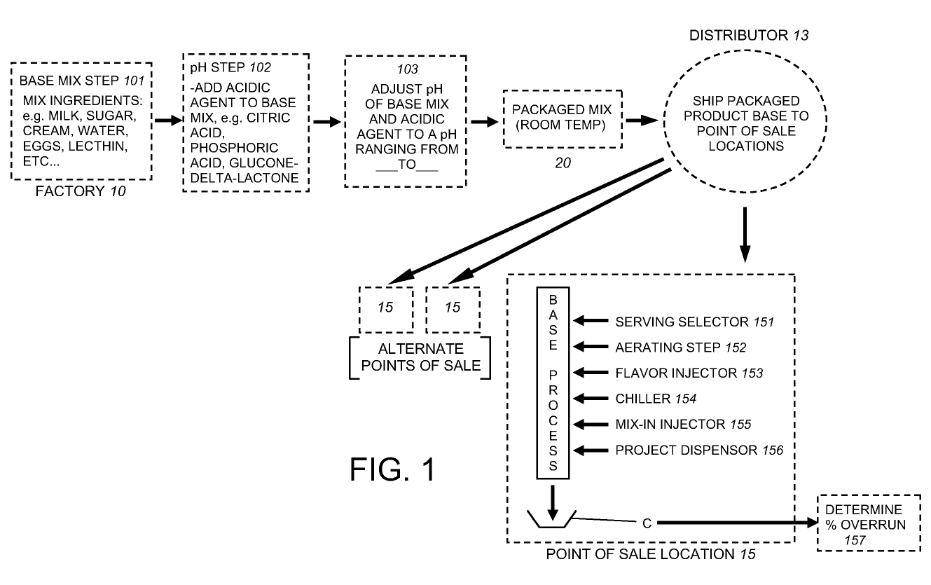

In FIG. 1 of the illustrative embodiment of the present invention, the basic ingredients are mixed together to produce a base in step 101, which in turn is mixed with an acidic agent to produce the final base mix composition in step 102. During step 103, the pH may be adjusted to a pH ranging from 6.8 to 5.3. In some instances, the pH of the base mix composition is adjusted such that a dessert product that results from the processing of the base mix composition has an increase in overrun percentage as a result of the decreased pH. In these instances, the resulting frozen dessert product is able to maintain a desirable consistency and flavor in addition to the increase in overrun percentage.

After the pH has been adjusted according to the present disclosure, the base mix composition and acidic agent may be aseptically packaged 20 so that the base mix composition is essentially free from foreign contaminants. The base mix composition, as shown in FIG. 1, may be shipped by a distributor 13, which may be the same as the manufacturer, in unrefrigerated form to the point of sale locations 15, where the final processing or final “manufacturing” of the finished product is to take place. Examples of point of sale locations include ice cream stands, restaurants, supermarkets, or any other site at which apparatus to manufacture portions from the subject food compositions is located. The shipment may be direct from the factory to the distribution site, or may involve intermediate distributors, wholesalers, warehousing, etc.

The base mix composition may be shipped by one or more of the common modes of shipping, such as large-volume trucks and other vehicles. It may also be shipped by transportation modes not commonly used for food products such as ice cream, e.g., by parcel post, by express carriers, and the like. Furthermore, distribution savings may be achieved in some cases by delivering the base product to food or beverage manufacturers or suppliers who in turn carry the base, along with their own products, to the distribution-centers. This either may be done on a fee-paying basis, to help the manufacturer or distributor to dispel part the cost of servicing a particular route, or from an ownership interest that the manufacturer or distributor has in some aspect of the distribution process, point of sale locations, etc.

### Methods of Converting the Subject Compositions to a Frozen Dessert

As summarized above, aspects of the disclosure include methods of converting the subject base mix composition which includes an acidic agent, to a dessert food product. In certain aspects, the dessert food product may be a frozen dessert product. The term “frozen desserts” is a market category that encompasses a wide variety of products that are served at temperatures below the freezing point of water. By “Frozen desserts,” it is meant a dairy-based food dessert or a non-dairy-based dessert. Examples of dairy-based desserts include ice cream, ice milk, sherbet, gelato, frozen yogurt, milk shakes, soft serve ice cream. Examples of non-dairy-based desserts include mellorine, sorbet, and water ices. Additional frozen desserts for use with the subject compositions and methods, include, frozen novelties such as bars, cones, and sandwiches.

Frozen dessert products, which may be produced in accordance with the methods of the illustrative embodiment of the present invention, may require mixing of selected liquid ingredients with a prescribed volume of air and/or freezing of the resultant mixture, and/or dispensing of the finished frozen product. The desirability of a finished dessert product is often directly related to the manner and the degree to which air is metered and blended with the liquid ingredients of the mixture, referred to herein as overrun, and the manner in which the blended mix is frozen and then dispensed.

For example, the subject base mix composition may be converted to a frozen dessert by atomizing the subject base mix compositions and mixing it with a fluid, such as a gas, and thereafter thoroughly mixing them to form a smooth, relatively homogeneous product the composition of which is controllable over a wide range of mixtures. In one exemplary embodiment, the subject base mix composition may be atomized before it is mixed with the gaseous fluid. In another exemplary embodiment, the atomization occurs concurrently with the mixing.

In certain instances, mixing may be achieved by passing the base mix composition under pressure through an extended conduit under conditions such that turbulent mixing occurs within the conduit. In particular, in the formation of an aerated product, such as ice cream or frozen yogurt, the atomization process breaks up the subject food compositions into fine particles, while the confinement of the particles and air stream in the extended conduit creates turbulent mixing of those ingredients. The turbulent mixing causes the air to become thoroughly blended with the fluid mix particles.

The amount of aeration in the product is a function of a number of factors, such as the length of the extended conduit, its inside diameter, the discharge velocity from the mixing space into the conduit, the particle size of the base mix composition, the ratio of the gas to the base mix composition, the volume flow rate, the density and viscosity of the composition, the surface tension, and the temperature of the mixture. During transit through the turbulent mixing passage, a flavoring and/or other additive(s) may be thoroughly mixed with each other and/or with the air to form a smooth relatively homogeneous product of fine particles. Although the extent of mixing may be controlled by varying one or more of these factors, the conduit length provides a convenient basis for control of the amount of aeration.

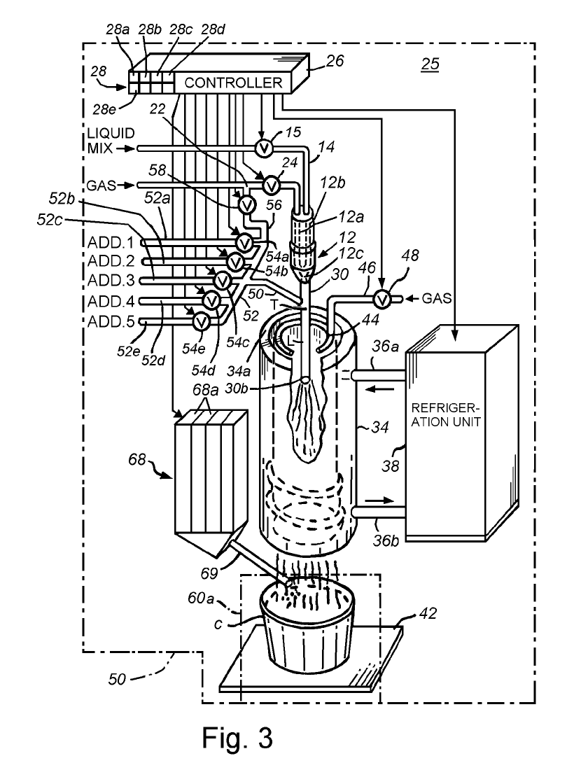

A typical device for converting the base mix and acidic agent combination, into a frozen dessert is depicted in FIG. 3. In this example, the device for producing a frozen dessert product such as ice cream is indicated generally by on site production machine 25. The on site production machine 25 is illustratively located at a point of sale 15. The subject base mix composition as described above, which includes an acidic agent has been mixed together and are essentially free from foreign contaminants due to the aseptic packaging process. The mixed composition is added to the mixing chamber defined, in this embodiment, by a vertically oriented air atomizing nozzle 12 having a first inlet 12a for liquid, a second inlet 12b for air or other gas, and a single discharge outlet 12c. Connected to the inlet 12a is a conduit or tube 14 which leads from a source (not shown) of the subject base mix composition to the inlet 12a of nozzle 12.

As noted above, in this example, the base mix compositions is for making a food product, such as a frozen food product, for instance, an ice cream which may further include an aerating step 152. The gas for aerating the liquid mix, which includes the subject base mix composition, is supplied to nozzle 12 by a pipe or conduit 22 leading from a gas source (not shown) which delivers the gas at a pressure above atmospheric to the inlet 12b of nozzle 12. Pressures from 5 psi to over 100 psi may be used in the gas delivery in system 25. The gas may be air or any other non-toxic gas customarily used to provide overrun or bulk in conventional ice cream products. The flow of the gas to nozzle 12 is controlled by a solenoid-actuated valve 24 in line with pipe 22. The operations of valves 16 and 24 are controlled by output signals from a controller 26 which has an accessible key pad 28 by which an operator can control the operation of apparatus 10.

The atomized mix, which includes the base mix composition that issues from the mixing chamber, e.g., from nozzle outlet 12c, is directed into one end of a relatively long, e.g. 2 to 24 inches, relatively small diameter, e.g. 0.08 to 0.24 inches, turbulent mixing passage in the form of a conduit 30 wherein the effluent from nozzle 12 is subjected to considerable turbulence and buffeting because of passage through the conduit. Thus, in the conduit, there is violent turbulent mixing of the atomized mix's particles and the gas, as shown as T in FIG. 3. This violent turbulence causes the particles of the base mix composition to coalesce and form somewhat larger particles. At the same time, gas is entrapped within the particles and consequently, the fluid issuing from the discharge end 30b of conduit 30 is approximately uniform in size, relatively small aerated particles with the air enclosed within an outer generally continuous “skin” formed by the mix of the food compositions.

During passage through the cooling chamber, the particles are “flash” frozen in a few, e.g., 1 to 10, seconds due to the relatively high ratio of surface area to volume of the particles emerging from the conduit in step 154. The small particles emerging from the conduit, combined with the flash freezing of each particle, produce a uniform and smooth frozen dessert in accordance with the present invention. Further, it is calculated that the energy requirements of the process lie within the range of conventional freezing machines and thus there is no special energy requirements to run machine 25.

Referring again to FIG. 3, positioned below the turbulence conduit 30 is a vertically oriented tubular cooling chamber 34 which has a central passage 34a for receiving the discharge end 30b of conduit 30, the chamber extending an appreciable distance below the conduit. Formed in the wall of chamber 34 is a helical passage 36 for circulating refrigerant through the chamber. The upper and lower ends of the passage 36 are connected by pipes 36a and 36b to the outlet and inlet, respectively, of a refrigeration unit 38. Unit 38 may also be controlled by controller 26.

Spaced below the lower end of chamber 34 is a horizontal shelf or tray 42 for supporting a container such as a paper or plastic cup C. Cup C is normally positioned directly below the central passage 34a in chamber 34 so that it is in position to catch or receive ice cream dropping under the influence of gravity from the lower end of the chamber passage 34a.

The diameter of chamber passage 34a is made sufficiently large so that the aerated mix particles issuing from the conduit end 30a may not contact and coat the wall of that passage. This minimizes the need to clean that surface. The buildup of particles on that interior wall can be further avoided by providing an air barrier or boundary layer adjacent to the passage wall. To provide such an air boundary layer, apparatus 10 may include, at the top of chamber passage 34a, a circular pipe 44 having a multiplicity of small holes (not shown) in its underside. Pipe 44 is connected to a gas source (not shown) by way of a pipe 46 having an in-line solenoid-actuated valve 48 controlled by controller 26. When valve 48 is opened, e.g. just before each dispensing cycle, a downwardly directed cylindrical layer of air helps isolate the wall of passage 34a from the fluid issuing from conduit 30.

The components of apparatus 25 may be housed in a housing shown in phantom by 60 in FIG. 3, an appropriate opening 60a being provided in a wall of housing 60 to provide access to the shelf 42 so that a cup C can be positioned on the shelf as shown in FIG. 3 in which is dispensed the converted frozen dessert according to the present invention in step 156.

Key pad 28 has selection keys or buttons 28a to 28e corresponding to the valves 54a to 54e to enable the operator to select the flavor of the ice cream product to be dispensed by apparatus or machine 25 in step 151 of FIG. 1. Controller 26 is programmed so that when the operator presses a key, for instance key 28a, the controller 26 applies timed actuating signals to valves 16 and 24, thereby opening those valves so that non-flavored liquid ice cream mix and gas are fed to nozzle 12 in the proper ratio. As nozzle 12 sprays these fluids into conduit 30, controller 26 sends a signal to valve 54a opening that valve so that additive 1, e.g. chocolate syrup, is injected by way of manifold 52 into conduit 50, which intersect with conduit 30, so that the additive is entrained in the effluent from nozzle 12 and thoroughly mixed into the liquid mix being aerated in the conduit 30 thereby providing a flavor injection to the non-flavored liquid mix in step 153. The signals from controller 26 that control valves 16,24, and 54a cause those valves to remain open for the time required for the apparatus 25 to dispense a selected volume of ice cream product, e.g. one portion or serving of chocolate ice cream, that will fill the cup C on shelf 42. Then valves 16,24, and 54a close so that substantially no additional fluid flows from the conduit 30.

The illustrated apparatus/machine also allows for addition of liquid or solid materials to the frozen product in container C in step 155 of FIG. 1. For this, a plurality of compartment dispensers 68, hereinafter the dispenser, are provided adjacent to chamber 34. The dispenser has several compartments 68a which may contain various materials such as chopped nuts, jimmies (sprinkles), chocolate syrup, etc. In response to actuation of the appropriate key of key pad 28, controller 26 causes the dispenser to dispense the selected material through a common outlet tube 69 whose discharge end overlies container C. The material will be incorporated into, or added to the top of, the product in container C depending upon when the dispensing is commenced and ended.

As soon as the cup C has been filled, it can be removed and replaced by an empty cup. The operator can then fulfill the request of the next customer. If that next customer wishes a different flavor ice cream, e.g. vanilla, the operator can depress the key pad key corresponding to that flavor, e.g. key 28c. In response, controller 26, in addition to opening valves 16 and 24 as before, will open valve 54c so that vanilla flavoring will be fed to conduit 30 and entrained in the non-flavored ice cream mix issuing from nozzle 12. In accordance with the present disclosure, each customer will receive ice cream in cup C.

The overrun of the resulting dessert product, for example, the ice cream product in cup C, may be calculated by the formula: ((mass of aerated composition-mass of mix)/mass of mix)×100) in step 157 of FIG. 1. This may be done at the point of sale 15 or at the manufacturing facility. The overrun percentage is generally calculated to as a added quality control check to ensure the proper amount of acidic agent was added to the base mix at the manufacturing facility. If the proper amount of acidic agent was added to the base mix at the manufacturing facility, the frozen dessert, e.g., the ice cream in cup C above, will have an increased overrun percentage due to the addition of a specific amount of an acidic agent to the base mix. In addition to the increase in overrun percentage, the resulting frozen dessert product has a desirable consistency and flavor even though the pH of the base mix composition was adjusted to range from 6.8 to 5.2. Thus, the resulting frozen dessert product, e.g., the ice cream in cup C has optimized and efficient volumes while less costly to the manufacturer because less base mix is utilized to produce the frozen dessert product.

Advantageously, the present invention provides for a system and method for producing an a frozen food product with an increased overrun percentage without the use of expensive machinery and the like while at the same time providing a customer with their desired flavoring without the adverse flavoring effects typically caused from adding an acid to a product.

The above method and apparatus is exemplary and not to be construed as a limitation. Additional exemplary methods and apparatuses, known to one of skill in the art, may be employed for converting the subject base mix composition to a frozen dessert. For example, additional methods and apparatuses for use in the present invention are described in U.S. Pat. Nos. 5,292,030; 5,433,967; 5,473,909; 5,603,257; 5,727,713; 5,758,571; 5,868,065; 6,698,228; 6,745,595; 6,907,741; 6,941,858; 6,952,928; 7,052,728; 7,131,279; and in US Patent Publication Nos: 2006/0054614; 2006/0162348; 2006/0162347; 2006/0003065; 2007/0251260; and in PCT Application Nos.: WO 92/102146; WO 03/041513; WO 2004/019707; and WO 2006/076733; the disclosures of which are herein incorporated by reference.

All publications and patents cited in this specification are herein incorporated by reference as if each individual publication or patent were specifically and individually indicated to be incorporated by reference.

It is also to be understood that this invention is not limited to particular embodiments described herein, as such, the present invention may of course vary. It is also to be understood that the terminology used herein is for the purpose of describing particular embodiments only, and is not intended to be limiting. Unless defined otherwise, all technical terms used herein have the same meaning as commonly understood by one skilled in the art to which this invention belongs.

Where a range of values is provided, it is understood that each intervening value, to the tenth of the unit of the lower limit unless the context clearly dictates otherwise, between the upper and lower limit of that range and any other stated or intervening value in that stated range, is encompassed within the invention. The upper and lower limits of these smaller ranges may independently be included in the smaller ranges, and are also encompassed within the invention, subject to any specifically excluded limit in the stated range. Where the stated range includes one or both of the limits, ranges excluding either or both of those included limits are also included in the invention.

It is further noted that the claims may be drafted to exclude any optional element. As such, this statement is intended to serve as antecedent basis for use of such exclusive terminology as “solely,” “only” and the like, in connection with the recitation of claim elements, or the use of a “negative” limitation.

As will be apparent to those of skill in the art upon reading this disclosure, each of the individual embodiments described and illustrated herein has discrete components and features which may be readily separated from or combined with the features of any of the other several embodiments without departing from the scope or spirit of the present invention. Any recited method can be carried out in the order of events recited or in any other order which is logically possible.

While the invention has been described with reference to the specific embodiments thereof, it should be understood by those skilled in the art that various changes may be made and equivalents may be substituted without departing from the true spirit and scope of the invention. In addition, many modifications may be made to adapt a particular situation, material, composition of matter, process, process step, or steps, to the objective, spirit, and scope of the invention. All such modifications are intended to be within the scope of the claims appended hereto.

What is claimed is:

1. A food composition, comprising:
a base mix for producing a dessert product;
an acidic agent, added to the base mix during production of the dessert product to decrease the pH of the base mix pH to a range of about 6.8 to 5.2, wherein the decreased pH aides in increasing the overrun percentage of the dessert product.

2. The base mix of claim 1, wherein the acidic agent is a food grade acid.

3. The base mix of claim 2, wherein the food grade acid is selected from the group consisting of acetic acid, adipic acid, citric acid, erythorbic acid, fumaric acid, lactic acid, malic acid, phosphoric acid, tartaric acid, and benzoic acid.

4. The base mix of claim 3, wherein the food grade acid is citric acid.

5. The base mix of claim 3, wherein the food grade acid is phosphoric acid.

6. The base mix of claim 1, wherein the acidic agent is a food grade acid precursor.

7. The base mix of claim 6, wherein the food grade acid precursor is glucono-delta-lactone.

8. The base mix of claim 1, wherein the amount of acidic agent to be included ranges from 0.005% to 0.1%.

9. The base mix of claim 1, wherein the resultant dessert product has a pH of about 6.1.

10. The base mix of claim 1, further comprising one or more of the following ingredients: milk; sugar; cream; corn syrup; water; carrageenan; locust bean gum; and guar gum.

11. The base mix of claim 10, further comprising one or more of the following ingredients: sodium caseinate; whey solids; egg yolks; lecithin; and salt.

12. The base mix of claim 11, wherein the base mix is processed to produce a frozen dessert product.

13. A frozen dessert product comprising a base mix, which base mix includes an acidic agent, wherein the frozen dessert product is produced in such a manner that the dessert product evidences an increased in overrun percentage when compared to a frozen dessert product produced from a base mix without the additional acidic agent to the frozen dessert product during production of the frozen dessert product.

14. The frozen dessert product of claim 13, wherein the overrun percentage is in an amount ranging from 30% to 60%.

15. A method of increasing overrun percentage of a frozen dessert product comprising:
providing an acidic agent to a base mix having a pH in the range of about 6.8 to 6.3, and processing the base mix to produce a dessert product having a pH in the range of about 6.3 to 5.2.

16. The method of claim 16, wherein the acidic agent decreases the pH of the base mix to a range from about 6.8 to 5.2.

17. The method of claim 16, wherein the base mix has a final pH of about 5.4.

18. The method of claim 17, wherein the acidic agent is a food grade acid.

19. The method of claim 18, wherein the food grade acid is selected from a group consisting of: acetic acid, adipic acid, citric acid, erythorbic acid, fumaric acid, lactic acid, malic acid, phosphoric acid, tartaric acid, and benzoic acid.
